(19) United States
(12) Patent Application Publication
(10) Pub. No.: US 2002/0169930 A1
(43) Pub. Date: Nov. 14, 2002

(54) Memory access control system, method thereof and host bridge

(75) Inventor: Hiroyuki Hagiwara, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/119,906

(22) Filed: Apr. 11, 2002

(30) Foreign Application Priority Data
May 14, 2001 (JP) 2001-143223

(51) Int. Cl. G06F 12/00

(52) U.S. Cl. 711/143

(57) ABSTRACT

The present invention includes a host bridge which is provided with an address hit decision circuit 220 for detecting coincidence between a read access address of a main memory 300 held in an address hold circuit 210 and a line address involved in write back operation by a processor 100 and a memory access control circuit 230 for, if hit is decided, taking in write data involved in the write operation and also canceling the access to the main memory 300.

### BACKGROUND OF THE INVENTION

1. Field of the Invention

The present invention relates to a memory access control system employed in such a configuration that a processor having a write back type cache and a host bridge commonly use a main memory via a local bus.

2. Description of the Related Art

Conventionally, access from an external master to a main memory via a host bridge has been made by placing processor's access in a write through mode in order to prevent the processor from performing write back operation when the host bridge tries to access the main memory.

In this case, the host bridge can make fast access, whereas in the processor, the write back operation is not completed until write data is stored in the main memory, which degrades the performance of the processor.

If, to avoid this problem, access by the processor is tried in the write back mode, however, it is interrupted by the write back operation performed by the processor as mentioned above, so that the main memory access by the host bridge can be performed only after this write back operation is completed, thus greatly increasing the latency of access from the external master to the main memory.

### SUMMARY OF THE INVENTION

In view of the above, it is an object of the present invention to provide a main memory access control system that when read access to a main memory is awaited because of write-back operation by a processor, if the write back operation-destination access address in the main memory coincides with the read access-destination address, the system takes in write data involved in the write back operation to thereby obtain desired data earlier than otherwise and also cancels the main memory read access to thereby reduce traffic of a local bus.

A memory access control system according to the present invention having a configuration that a processor having a write back type cache and a host bridge having an external interface commonly use a main memory via a local bus, wherein if write back operation by said processor occurs to said main memory when said host bridge tries to perform read access to said main memory, said host bridge takes in write data involved in said write back operation if a memory access address subject to said write back operation coincides with an address subject to said read access.

According to the present invention, if a memory access address subject to a write back operation coincides with a read access-destination address, a host bridge can take in write data involved in the write back operation to thereby obtain desired data earlier than otherwise. Accordingly, an access latency necessary for an external master connected to the host bridge can be reduced.

When having taken in the write back data, the host bridge can cancel the main memory read access, thus reducing the local bus traffic. This may improve the performance of a multi-processor configuration.

In the multi-processor configuration, the write back data may be taken in by any other processors. This can reduce the local bus traffic, thus expectedly improving the performance of the multi-processor configuration.

A host bridge according to present invention having a configuration that a main memory is used commonly via a local bus, comprising: an address hold circuit for holding such an address in said main memory as to be accessed; an address hit decision circuit for deciding whether a line address involved in write back operation by a processor coincides with the address held in said address hold circuit; and a memory access control circuit for, if coincidence is detected by said address hit decision circuit, taking in write data involved in said write back operation and also canceling the access to said main memory.

The Host bridge according to the present invention, if a memory access address subject to write back operation coincides with a read access-destination address, a host bridge takes in write data involved in the write back operation to thereby obtain desired data earlier than otherwise. Accordingly, an access latency necessary for an external connected to the host bridge can be reduced.

### BRIEF DESCRIPTION OF THE DRAWINGS

FIG. 1 is a diagram for showing a configuration of a memory access control system of the present invention;

FIG. 2 is a diagram for showing one embodiment of the memory access control system of the present invention;

FIG. 3 is a timing chart (in a case where hit decision is given) for showing operation of the memory access control system of the present invention;

FIG. 4 is a timing chart (in a case where mis-hit decision is given) for showing operation of a conventional memory access control system; and

FIG. 5 is a flow chart for showing a processes of memory access control according to present invention.

### DESCRIPTION OF THE PREFERRED EMBODIMENTS

The following will describe embodiments of the present invention with reference to the drawings.

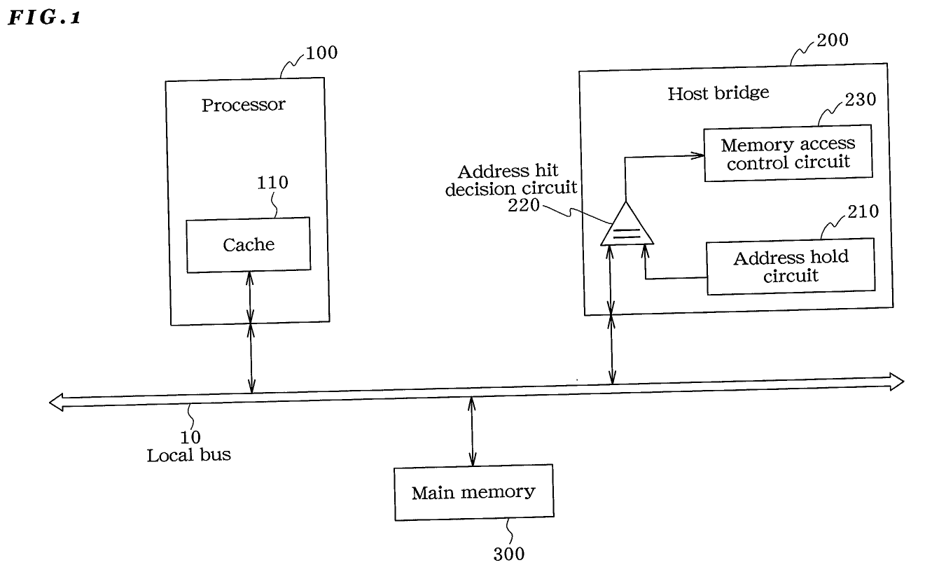

As shown in FIG. 1, a memory access control system of one embodiment of the present invention comprises a processor 100 having an inner cache 110 and a host bridge 200 having external interface commonly access to the main memory 300 via a local bus 10. The host bridge 200 including an address hold circuit 210 for holding such an address in a main memory 300 as to be accessed (read access), an address hit decision circuit 220 for deciding coincidence/non-coincidence by comparing such an access address (line address) in the main memory 300 as to be accessed by write back operation by a processor 100 to an address (address to be accessed by a host bridge 200) held in the address hold circuit 210, and a memory access control circuit 230 for, if hit is decided by the address hit decision circuit 220, taking in write data involved in the write back operation by the processor 100 and also canceling the read access to the main memory 300.

By the memory access control system of the present embodiment, if write back operation by the processor 100 occurs when the host bridge 200 tries to access the main memory 300 and, therefore, the host bridge 200 is made to await the memory access, the address hit decision circuit 220 decides hit/mis-hit by comparing an memory access address subject to the write back operation and an access address to be accessed by the host bridge 200. If hit is decided by the address hit decision circuit 220, the memory access control circuit 230 takes in write data involved in the write operation and also cancels the awaited memory access. Accordingly, the host bridge 200 can operate as if it has read out the most recent data from the main memory 300.

Conventionally, after completion of write back operation, the host bridge 200 accesses the main memory 300 to read out desired data. However, by the memory access control system of the present invention, if data to be written to the main memory 300 by the write back operation coincides with data to be read out by the host bridge 200, the data supplied on a local bus 10 for the write back operation can be taken in by the host bridge 200, to be obtained early. Also, when the data supplied on the local bus 10 by the write back operation is taken in by the host bridge 200, the access to the main memory 300 can be canceled, thus reducing traffic of the local bus 10.

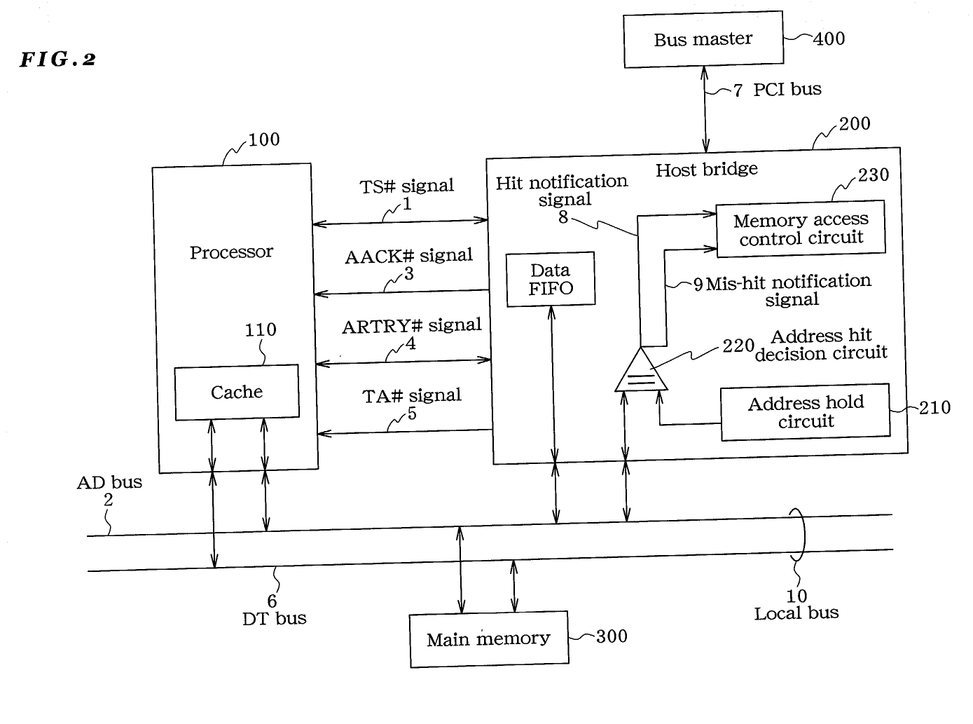

FIG. 2 shows an example where a bus protocol for use in a commercially available processor PowerPC60x (trade name) is applied. The basic configuration of the memory access control system shown in FIG. 2 is the same as that shown in FIG. 1. Between the processor 100 and the host bridge 200 are connected a line for TS# signal 1 indicating starting of transfer, an AD bus 2 indicating an address bus, a line for AACK# signal 3 indicating ending of an address bus occupation period, a line for ARTRY# signal 4 indicating a transfer retry request, a line for TA# signal 5 indicating that data valid to a data bus is being transferred, and a DT bus 6 indicating the data bus. Also, the host bridge 200 incorporates a data FIFO 240 and is connected with a bus master 400 through a PCI bus 7. Note here that symbol “#” attached to the end of the name of each signal indicates that the signal is activated at the LOW level.

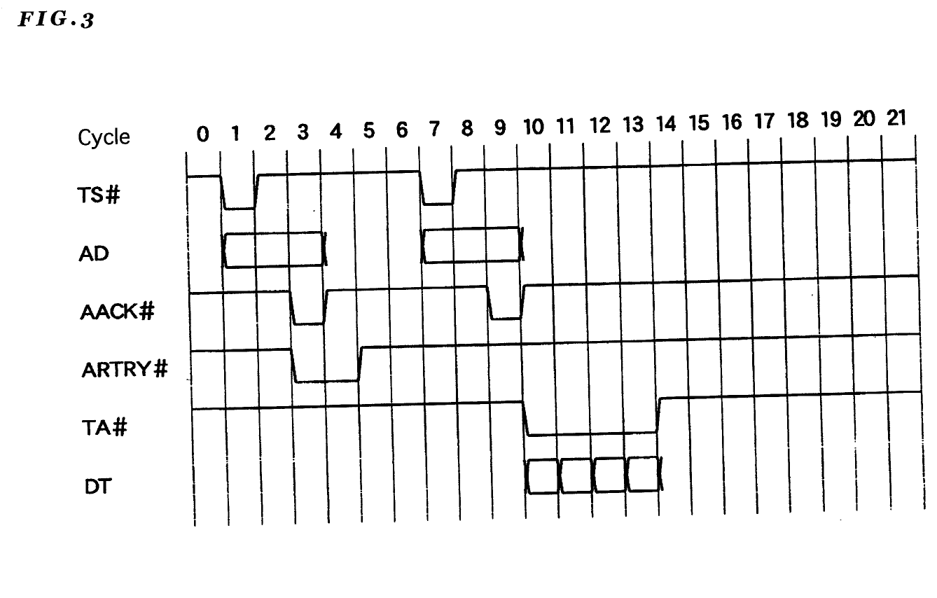

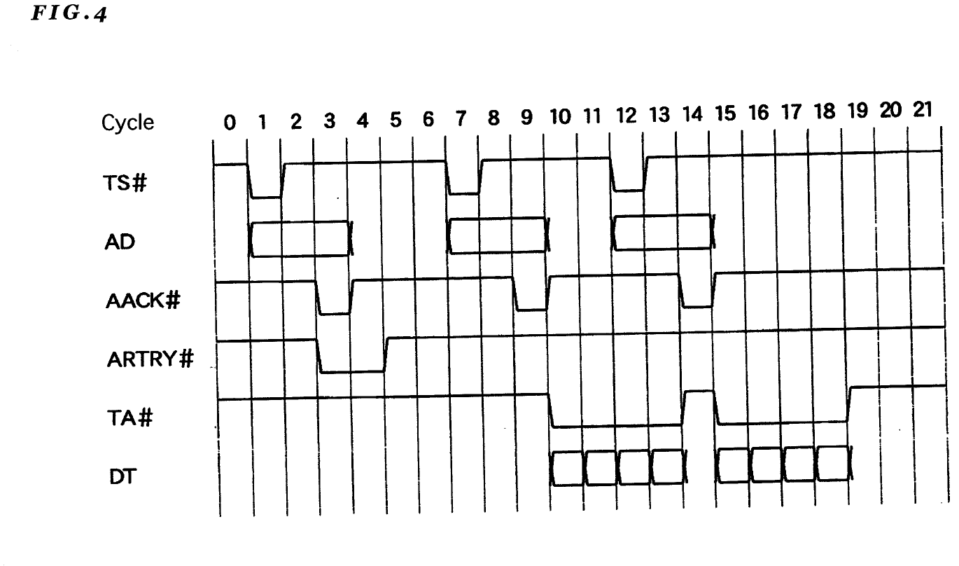

The operation is described with reference to FIGS. 2, 3, and 4. FIG. 3 shows the operation when the address hit decision circuit 220 decides hit. If the address hit decision circuit 220 decides mis-hit, on the other hand, the operation of FIG. 4 is performed.

While the cache 110 in the processor 100 is operating as a write back cache, write data (A) to be written by the processor 100 to the main memory 300 is stored in the cache 110 to then the status of its cache line is modified. In this case, a region (α) in the main memory that corresponds to the same address as this cache line is not updated. When in this state the external master 400 performs read operation to the region (α) in the main memory 300, the host bridge 200 receives an access address from the external master 400, holds this received address in the address hold circuit 210, and then asserts this address together with the TS# signal 1 on the AD bus 2 (cycle 1 in FIG. 3).

The assertion period of the AD bus 2 (address bus occupation period) is controlled by the host bridge 200 and continues until the host bridge 200 asserts the AACK# signal 3 (for at least three cycles in this embodiment) During the address bus occupation period, the processor 100 snoops the addresses on the AD bus 2 and, if coincidence (hit) with the address of the cache line is detected, asserts the ARTRY# signal 4 (cycles 3 and 4 in FIG. 3), thereby instructing the host bridge 200 for suspension of the above-mentioned ongoing access and retrial.

Upon reception of the instruction for the suspension of the ongoing access and retrial, the memory access control circuit 230 temporarily suspends the ongoing access and enters a snoop hit status. The memory access control circuit 230 in the snoop hit status then snoops the AD bus 2 immediately after the processor 100 has accessed the memory therethrough.

At the same time as having asserted the ARTRY# signal 4, the processor 100 starts to write back the write data (A) in the cache 110 to the region (α) in the main memory and, after bus arbitration, asserts the TS# signal 1 and the AD bus 2 (cycle 7 in FIG. 3).

Then, the address hit decision circuit 220 in the host bridge 200 compares the address held in the address hold circuit 210 to a line address on the AD bus 2 and, if address hit is detected, sends a hit notification signal 8 to the memory access control circuit 230 to notify it of the hit and, if address mis-hit is detected, sends a mis-hit notification signal 9 to the memory access control circuit 230 to notify it of the mis-hit.

When having received the hit notification signal 8 when in a snoop hit status, the memory access control circuit 230 cancels the temporarily suspended memory access operation and then exits the snoop hit status to enter a data wait status. Also, when the main memory 300 enters a data reception enabled state, the memory access control circuit 230 asserts the TA# signal 5 to thereby prompt the processor 100 to output the data to the DT bus 6 (cycles 10-13 in FIG. 3).

When having received the TA# signal 5, the processor 100 outputs a data line containing the write data (A) to the DT bus 6. At the same time, the memory access control circuit 230 which has been in the data wait status takes the data line into the data FIFO 240 and then transfers this data via the PCI bus 7 to the bus master 400.

FIG. 3 shows a case where the address involved in the write back operation is decided to be hit in the host bridge 200, wherein the transferring through the local bus comprises 13 cycles.

If the address involved in the write back operation is decided to be mis-hit, on the other hand, the memory access control circuit 230 retries the temporarily suspended main memory access after the write back operation is completed. In this case, the transferring is the same as that of the conventional operation, comprising 18 cycles as shown in FIG. 4.

Although the embodiment has been described with reference to the single-processor configuration, the memory access control system of the present invention is applicable also to a multi-processor configuration. Note here that in the multi-processor configuration, each processor can be provided with the address hit decision function to permit any other processors to take in write data involved in write back operation. This decreases traffic of the local bus, thus expectedly improving the performance of the multi-processor configuration.

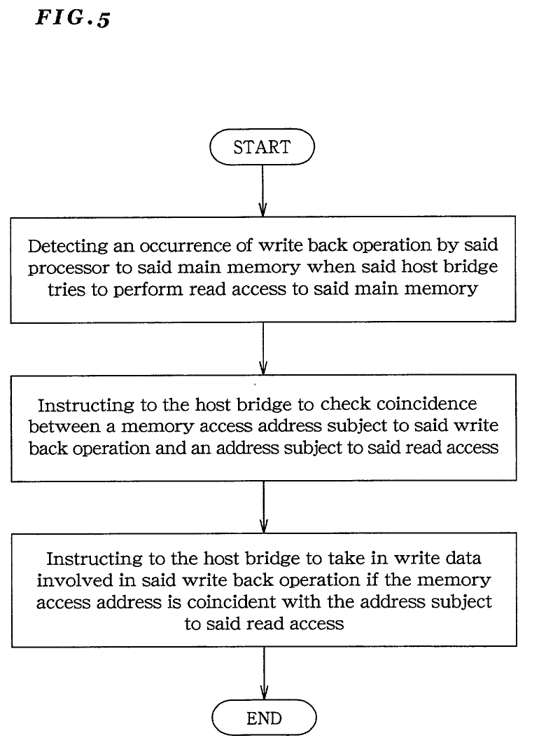

Present invention can be achieved by computer program product as shown in FIG. 5. That is, the computer program product is used for controlling memory access to a main memory. This program is stored in computer readable storage medium, wherein the main memory is commonly accessed by a processor having a write back type cache and a host bridge having an external interface via a local bus. The program product comprising processes of: detecting an occurrence of write back operation by said processor to said main memory when said host bridge tries to perform read access to said main memory; instructing to the host bridge to check coincidence between a memory access address subject to said write back operation and an address subject to said read access; and instructing to the host bridge to takes in write data involved in said write back operation if the memory access address is coincident with the address subject to said read access.

As mentioned above, by the memory access control system of the present invention, when read access to the main memory is awaited because of write back operation by the processor, if a main memory address to be accessed by the write back operation coincides with the read access address, write data involved in the write back operation can be taken in to thereby obtain desired data early and also the main memory read access can be canceled to thereby reduce traffic of the local bus. The local bus traffic can thus be reduced, thereby expectedly improving the performance of a possible multi-processor configuration and also reducing the access latency of an external master connected to the host bridge.

What is claimed is:

1. A memory access control system having a configuration that a processor having a write back type cache and a host bridge having an external interface commonly use a main memory via a local bus, wherein if write back operation by said processor occurs to said main memory when said host bridge tries to perform read access to said main memory, said host bridge takes in write data involved in said write back operation if a memory access address subject to said write back operation coincides with an address subject to said read access.

2. The memory access control system according to claim 1, wherein when having taken in the write data involved in said write back operation, said host bridge cancels the read access to said main memory.

3. A memory access control system having a configuration that a plurality of processors each having a write back type cache commonly uses a main memory via a local bus, wherein if, when one of the plurality of processor tries to perform read access to said main memory, write back operation by any other of the plurality of processors occurs to said main memory, said one processor takes in write data involved in said write back operation if a memory access address subject to said write back operation coincides with an address subject to said read access.

4. The memory access control system according to claim 3, wherein when having taken in the write data involved in said write back operation, said one processor cancels the read access to said main memory.

5. A memory access control system having a configuration that a plurality of processors each having a write back type cache and a host bridge having an external interface commonly use a main memory via a local bus, wherein if, when one of the plurality of processor or said host bridge tries to perform read access to said main memory, write back operation by any other of the plurality of processors occurs to said main memory, said one processor or said host bridge takes in write data involved in said write back operation if a memory access address subject to said write back operation coincides with an address subject to said read access.

6. The memory access control system according to claim 5, wherein when having taken in the write data involved in said write back operation, said one processor or said host bridge cancels the read access to said main memory.

7. A host bridge having a configuration that a main memory is used commonly via a local bus, comprising:
an address hold circuit for holding such an address in said main memory as to be accessed;
an address hit decision circuit for deciding whether a line address involved in write back operation by a processor coincides with the address held in said address hold circuit; and
a memory access control circuit for, if coincidence is detected by said address hit decision circuit, taking in write data involved in said write back operation and also canceling the access to said main memory.

8. A computer program product for controlling memory access to a main memory stored in computer readable storage medium, wherein the main memory is commonly accessed by a processor having a write back type cache and a host bridge having an external interface via a local bus, the program product comprising processes of:
detecting an occurrence of write back operation by said processor to said main memory when said host bridge tries to perform read access to said main memory;
instructing to the host bridge to check coincidence between a memory access address subject to said write back operation and an address subject to said read access; and
instructing to the host bridge to takes in write data involved in said write back operation if the memory access address is coincident with the address subject to said read access.

9. A memory access controlling method, wherein the main memory is commonly accessed by a processor having a write back type cache and a host bridge having an external interface via a local bus, the method comprising steps of:
detecting an occurrence of write back operation by said processor to said main memory when said host bridge tries to perform read access to said main memory;
instructing to the host bridge to check coincidence between a memory access address subject to said write back operation and an address subject to said read access; and instructing to the host bridge to takes in write data involved in said write back operation if the memory access address is coincident with the address subject to said read access.
